(19) United States
(12) Patent Application Publication
(10) Pub. No.: US 2015/0170281 A1
(43) Pub. Date: Jun. 18, 2015

(54) SYSTEM AND METHOD FOR CONDUCTING AN EXCHANGE AUCTION

(71) Applicant: Creditex Group, Inc., New York, NY (US)

(72) Inventors: Chris Crowley, Brooklyn, NY (US); Mark Rowell, London (GB)

(21) Appl. No.: 14/633,445

(22) Filed: Feb. 27, 2015

Related U.S. Application Data
(63) Continuation of application No. 14/174,001, filed on Feb. 6, 2014.
(60) Provisional application No. 61/765,302, filed on Feb. 15, 2013.

(51) Int. Cl. G06Q 40/04

(52) U.S. Cl. CPC G06Q 40/04

(57) ABSTRACT

A method for conducting an exchange auction includes a computer receiving financial positions data defining long and short positions associated with a first financial instrument. The method further includes matching, by the computer, one of the short positions and one of the long positions and generating a first proposed trade including the matched positions. The method further includes generating, by the computer, a second proposed trade including a short position and long position associated with second financial instrument, such that a net notion of the first proposed is equal to a notional of the second propose trade. The method further includes executing the first and second proposed trades.

### TECHNICAL FIELD

This disclosure is generally related to conducting multilateral exchange auctions, and more particularly to methods and systems for conducting a multilateral exchange auction that results in offsetting of positions associated with a first financial instrument and replacing the offset positions with replacement positions associated with a second financial instrument.

### BACKGROUND

Recent changes in regulation of financial instruments and derivatives trading has led to standardization efforts for tradable contracts. For example, recently standardized versions of Credit Default Swap (CDS) contracts have now become the only types of CDS contacts accepted by Clearinghouses. However, many traders still have positions in legacy financial derivatives, such as non-compliant CDS contracts, that were acquired before standardization regulations were enacted. Many of the traders may wish to replace their positions in legacy derivatives with similar positions in standardized derivatives.

Consequently, it is highly desirable to have a new type of an electronic exchange auction system and method that would make it possible to identify and match traders wishing to exchange their legacy positions for standardized positions and to execute trades which result in a flattening of legacy positions and replacement of flatted positions with standardized derivatives positions.

### SUMMARY

The present disclosure relates generally to a method and a system for conducting an exchange auction. In one embodiment, at least one computer may receive financial position data defining long and short positions associated with a first financial asset. The at least one computer may then match at least one long position and at least one short position defined by the financial position data. The at least one computer may then generate a first proposed trade that includes the matched positions. The at least one computer may further generate a second proposed trade including a long position and a short position associated with a second financial instrument, such that a notional of the second proposed trade is equal to a notional of the first proposed trade. The at least one computer may then execute the first and the second trades.

In another embodiment, a system for conducting an exchange auction may comprise an electronic auction server. The electronic auction server may be configured to receive financial position data defining long and short positions associated with a first financial asset. The electronic auction server device may further be configured to match at least one long position and at least one short position defined by the financial position data. The at least one electronic auction server device may further be configured to generate a first proposed trade that includes the matched positions, and a second proposed trade including a short position and a long position associated with a second financial instrument, such that a net notional of the second proposed trade is equal to a notional of the first proposed trade. The at least one electronic auction server device may further be configured to execute the first and the second proposed trades.

### BRIEF DESCRIPTION OF THE DRAWINGS

The foregoing summary and the following detailed description are better understood when read in conjunction with the appended drawings. Exemplary embodiments are shown in the drawings, however, it is understood that the embodiments are not limited to the specific methods and instrumentalities depicted herein. In the drawings:

FIG. 1 is a diagram illustrating an exemplary system for conducting an exchange auction.

FIG. 2 is a sequence diagram illustrating an exemplary method for conducting an exchange auction.

FIGS. 3A-3C illustrate an exemplary progression of financial positions associated with first and second exemplary proposed trades generated during an exemplary exchange auction.

FIG. 4 is a diagram illustrating an exemplary user interface for displaying and reviewing proposed trades generated during an exemplary exchange auction.

### DETAILED DESCRIPTION

The present disclosure relates generally to systems and methods for conducting an exchange auction. In one embodiment, an electronic auction server may receive data defining long and short positions associated with a first financial asset. The electronic auction server may then bi-laterally match some of the long and short positions and generate a proposed trade for each match. The electronic auction server may also generate a proposed replacement trade associated with a second financial asset for each proposed trade. Each of the replacement trades may be generated such that the net notional of the replacement trade is equal to the net notional of the corresponding proposed trade. The proposed trade and the replacement may then be executed together.

The term “electronic auction server” shall refer to any type of a computing device. The electronic auction server may comprise one or more processors configured to execute instructions stored in a non-transitory memory. The electronic auction server may be configured for conducting multi-lateral financial trade auctions, and for generating and executing financial trades. The electronic auction server may be embodied in a single computing device, while in other embodiments, an electronic auction server may refer to a plurality of computing devices housed in one or more facilities that are configured to jointly provide local or remote computing services to one or more users or user devices. The electronic auction server may send and receive data from user devices, data servers, or any other type of computing devices or entities over the Internet, over a Wi-Fi connection, over a cellular network or via any other wired or wireless connection or network known in the art.

The term “computer” shall refer to any electronic device or devices, including those having capabilities to be utilized in connection with an electronic auction system, such as any device capable of receiving, transmitting, processing and/or using data and information. The computer may comprise a server, a processor, a microprocessor, a personal computer, such as a laptop, palm PC, desktop or workstation, a network server, a mainframe, an electronic wired or wireless device, such as for example, a telephone, a cellular telephone, a personal digital assistant, a smartphone, an interactive television, such as for example, a television adapted to be connected to the Internet or an electronic device adapted for use with a television, an electronic pager or any other computing and/or communication device.

The term “network” shall refer to any type of network or networks, including those capable of being utilized in connection with an electronic autcion system, such as, for example, any public and/or private networks, including, for instance, the Internet, an intranet, or an extranet, any wired or wireless networks or combinations thereof.

The term “financial asset” shall refer to any type of financial instrument, such as, without limitation, outright options, spread options, option combinations, commodities, derivatives, shares, bonds and currencies. The term “derivatives” shall further refer to any type of credit default swap contracts, options, caps, floors, collars, structured debt obligations and deposits, swaps, futures, forwards and various combinations thereof or any other type of financial instruments that comprise an underlying asset.

The term “trade” shall refer to any type or part of a transaction or exchange that may occur in connection with one or more financial assets.

The term “user interface” shall refer to any suitable type of device, connection, display and/or system through which information may be conveyed to a user, such as, without limitation, a monitor, a computer, a graphical user interface, a terminal, a screen, a telephone, a personal digital assistant, a smartphone, or an interactive television.

The term “Modified Restructuring Credit Default Swap” (MR CDS) shall refer to any type of a credit default swap contract that provides a buyer of the CDS with protection if a restructuring event occurs. In one embodiment, MR CDS shall refer to CDS contracts that limit deliverable obligations to the CDS buyer in ways known in the art of CDS contracts.

The term “No Restructuring Credit Default Swap” (NR CDS) shall refer to any type of a credit default swap contract that does not provides a buyer of the CDS with protection if a restructuring event occurs. In one embodiment, NR CDS shall refer to CDS contracts that limit deliverable obligations to the CDS buyer in a standardized way mandated by financial regulations.

### Multilateral MR/NR Exchange Auction Process Overview

In a one exemplary embodiment, the present disclosure relates to a method of conducting an MR/NR multilateral auction that enables dealers to flatten their MR CDS positions and replace the flattened positions with NR CDS positions. In one embodiment, the replacement NR CDS contracts may adhere to Standard North American Corporate (SNAC) specifications. New (replacement) NR CDS contracts resulting from the auction may then be available for submission to a clearinghouse.

The auction process may begin with a scheduling phase. CDS contracts that are scheduled for an auction may be selected from a single financial sector. For example, North American Financial CDS contracts may be selected for one such auction. An invitation to participate in the auction may be sent to participating traders. The participating traders may respond by announcing their intention to participate. Parameters of the auction may be set up ahead of the auction to include (without limit): the selected CDS contracts, responding traders, and the time and date of the auction.

The auction process may then proceed to a submission phase. At a predetermined time during this phase, each of the participating traders may submit financial information to an electronic auction server. The submitted information may include proposed mid-level prices for MR CDS contracts, proposed mid-level prices for NR CDS contracts, outstanding long and short notional amounts of MR CDS contracts held by a trader, and, optionally, outstanding long and short notional of NR CDS contracts held by a trader. Alternatively, the traders may submit a mid-level price for MR CDS (or NR CDS) contracts and a preferred price differential between MR CDS and NR CDS contracts. The participating traders may submit data directly via screen input, via XLS (Microsoft Excel File) CSV (Comma Separated Value) format upload process, via web service submission process, via a direct link between a trader computer and the electronic submission server or any other available means.

The auction process may than proceed to mid review phase. During this phase the electronic auction server may calculate mid-prices for both MR and NR CDS contracts based on the proposed mid-price submissions by the participating traders. Calculated final mid-prices may then be transmitted to the participating traders for review. At this point, the participating traders may withdraw their positions from the auction if they are not satisfied with the determined mid-prices.

The auction process may than proceed to a trade review phase. During this phase, the electronic exchange server may generate matches between long and short positions submitted by the participating traders. The electronic exchange server may utilize an MR/NR matching algorithm. In one embodiment, MR/NR matching algorithm may convert the MR CDS notional amounts into deltas and line-up the open interest from all potential counterparties. The sign of the deltas may define whether a trader is buying or selling CDS protection. The matching algorithm may then create switches between the counterparties to flatten out the MR risk, by suggesting offsetting trades. The matching algorithm may then generate new NR SNAC CDS positions to replace the former flattened MR CDS positions.

The proposed trades generated during the trade review phase may include (without limit) the following information: notional of MR CDS contract to be bought or sold, notional of NR CDS contract to be bought or sold, leg delta (the reduction in MR CDS position and increase in NR CDS position), leg profit & loss (P&L) that may be defined as the cost impact of trade execution, trade identification (ID) and an option to cancel proposed trade(s). Each proposed trade may be generated in a bi-lateral fashion between two of the participating traders. The identity of each counter-party in each bi-lateral trade may be kept confidential. Each bi-lateral proposed trade may comprise MR CDS proposed trade leg and a connected NR CDS proposed trade leg.

During the trade review phase, the generated trades may be transmitted to the participating traders for review. The participating traders may review the trades and cancel the proposed trades they deem unsatisfactory. In one embodiment, the participating traders may only cancel both the MR CDS proposed trade and the connected NR CDS proposed trade, and may not cancel just one of the two connected proposed trades. In one embodiment, the traders may certify that they have agreed to all trades that were not explicitly canceled. At this point, all non-canceled trades may be booked and the trade review phase may close.

The auction process may then proceed to a re-match phase. During this phase, the steps of the trade review phase may be repeated for participating traders whose counter-party has canceled the proposed trade(s). In one embodiment, only the traders who have indicated that they want to participate in the re-match phase are included. After the eligible positions are determined, the re-match phase may operate similarly to the trade review phase described above.

### Exchange Auction Method

In another exemplary embodiment, the present disclosure relates to a method of conducting an exchange auction by a computer comprising a non-transitory memory for storing instructions and a processor for executing the instructions to perform certain functions. Optionally, the computer may comprise an electronic auction server. The computer may be configured to receive and send data to and from user devices and other servers over the Internet, over a Wi-Fi connection, over a cellular network or via any other wired or wireless connection or network known in the art.

As an initial step, the exemplary method may include receiving, by the computer, financial position data for at least one type of a financial asset traded on an electronic exchange. The financial position data may define a plurality of long and short positions held by a plurality of traders and associated with a first financial asset. In one embodiment, the first financial asset may comprise a derivative instrument having an underlying financial asset. For example, the first financial asset may be an MR CDS contract associated with bonds of a particular entity. In this embodiment, the financial position data may define whether each trader has protection or obligation(s) associated with the MR CDS contracts, and the notional value of said obligation or protection. The financial position data may also optionally define position tenor data that indicates a tenor of between zero and ten years (or other ranges), in quarterly increments (or other increments), for each of the long and short positions defined by said financial position data. Other methods of defining financial positions may also be used.

In one embodiment, the financial position data may be received in response to an exchange auction invitation generated by the computer and transmitted to one or more traders. The invitation may be configured to invite one or more traders to participate in the exchange auction. In this embodiment, the invitation may be transmitted to user devices (e.g., user computer) associated with the one or more traders via any kind of network known in the art. Each of the user devices may then transmit at least a portion of the financial position data to the computer via any kind of network known in the art. As an option, traders may only be permitted to submit the financial position data to the computer during a predetermined time window.

Each of the user devices associated with the one or more traders may also transmit proposed mid-price data for the first financial asset. For example, if the first financial asset is an MR CDS contract, each trader may submit a proposed mid-price for said MR CDS contract. Each of the user devices associated with the one or more traders may also transmit proposed mid-price data for a second financial asset. This second financial asset may be associated with the same underlying financial asset as the first financial asset. For example, if the first financial asset is an MR CDS contract associated with a specific bond, the second financial asset may be an NR CDS contract associated with said specific bond. Alternatively, the traders may submit a proposed mid-point of the first or second financial asset and a proposed price spread between said two financial assets. The computer may then calculate a trade price for the first and second financial assets to be used during the exchange auction. Notably, any of the algorithms known in the art may be used for this calculation, or alternatively, a proprietary algorithm may also be used to calculate a trade price. In one embodiment, submission of the proposed mid-prices may be limited to a predetermined time window defined by the computer.

As a next step, the computer may match at least one long position defined by the financial position data and an at least one short position defined by the financial position data. For example, an MR CDS obligation held by a first trader may be matched with an MR CDS protection held by a second trader. Notably, a plurality of matches may be generated by this matching process, including a plurality of bi-lateral matches between short and long positions. In another embodiment, a single position may be matched with a plurality of other positions in a bi-lateral fashion. For example, a single $100 million long position held by a first trader may be matched with one $70 million short position held by a second trader and one $30 million short position held by third trader. Each of the matches may then be treated as a separate bi-lateral match. In this example, the $100 million long position may be, essentially, treated as two separate long positions ($30 million long position and $70 million long position). Thus, the matching process may generate a collection of matched pairs, each pair comprising a matched short and a matched long position. The steps described below illustrate in detail the steps that may be used to process a single bi-lateral match involving one pair of matched positions. However, the same steps may be applied for every pair of matched positions of a collection of matched positions generated during the exchange auction.

After at least one long position and at least one short position are matched, the computer may generate a first proposed trade including the matched positions. In one embodiment, the matched long position may be associated with a first trader and the matched short position may be associated with a second trader. The first proposed trade may be a trade between the first trader and the second trader that results in a flattening of the long and the short positions. For example, the matched long position may be a $100 million long position belonging to the first trader and the matched short position may be a $100 million short position belonging to the second trader. In this example, the proposed trade may be an offsetting trade between the first trader and the second trader that functionally eliminates the risks associated with the positions for both the first and second traders. In another embodiment, the first proposed trade may be a sale of a long position from the first trader to the second trader. In yet another embodiment, where the notional of the matched long position and the matched short positions are not the same, only one of the positions may be completely offset by the first proposed trade. The other position may only be partially offset by the first proposed trade.

As a next step, the computer may generate a second proposed trade associated with a second financial asset. This second financial asset may be associated with the same underlying financial asset as the first financial asset. For example, if the first financial asset is an MR CDS contract associated with a specific bond, the second financial asset may be an NR CDS contract associated with the same specific bond. The net notional of the second proposed trade may be equal to the net notional of the first proposed trade. For example, if the first proposed trade was a sale of a $100 million long MR CDS position, the second proposed trade may be a purchase of a $100 million long NR CDS position. In one embodiment, the second proposed trade may be designed to create replacement positions for the matched long and short positions that are being offset or flattened by the first proposed trade. For example, if the first proposed trade results in offsetting of a $100 million long MR CDS position, the second proposed trade may be designed to create a replacement $100 million long NR CDS position. In this example, the execution of the first and second proposed trades results in an offsetting of the matched positions associated with a first financial asset and a creation of new replacement positions associated with a second financial asset, such that the notional of the replacement positions is equal to and offsets the notional of the matched positions associated with the first financial asset.

Optionally, the matched long position may belong to a first trader, and the matched short position may belong to a second trader. If this is the case, the computer may generate the first proposed trade and the second proposed trade to be between the first and the second traders. For example, the first proposed trade between the first and the second traders may serve to offset the matched long and short positions, while the second proposed trade may serve to create replacement positions for the offset portions of the matched positions. Once the first and second proposed trades are generated, the computer may present the generated trades to the first and second traders for approval. The information about the proposed trades may be transmitted to a user device associated with the first trader and a user device associated with the second trader, and displayed on a user interface of each of the user devices. Each of the first and second traders may then review the proposed trades, including the proposed notional amounts of each proposed trade and the price associated with each proposed trade, as well as any other information relating to the proposed trades. Subsequently, each of the traders may send an opt-out or opt-in indication to the computer. In one embodiment, taking no action for a predetermined period of time may indicate an acceptance or a rejection of the proposed trades. If the opt-out indication is received from either of the traders, neither the first nor second proposed trades are executed. If no opt-out indication is received or if an opt-in indication is received from both traders, the first and the second proposed trades may be executed by the computer, either simultaneously or sequentially.

As noted above, the steps of matching positions and generating proposed trades may be repeated for certain positions defined by the financial position data that were not completely offset during the initial auction. For example, it is possible that one of the traders has sent an opt-out indication, while the trader's counterparty did not opt-out. In this scenario, the position of the counterparty who did not opt-out may be eligible for a re-match auction. Other positions may also be included in the re-match auction. The steps performed by the computer during the re-match auction may be similar to those performed in the exchange auction described above. For example, the re-match auction may similarly involve matching the positions included in the re-match auction in a bi-lateral fashion, generating a proposed offsetting trade involving the matched positions and generating a proposed replacement trade in a manner described above.

### Exchange Auction System

An exemplary computer system for conducting an exchange auction in accordance with the present disclosure may comprise an electronic auction server. The electronic auction server may comprise one or more processors configured to execute instructions stored in non-transitory memory. Execution of the instructions may cause the electronic auction server to perform any of the features and functions described above, as well as those further described below. The electronic auction server may be embodied in a single computing device, while in other embodiments, the electronic auction server may refer to a plurality of computing devices housed in one or more facilities that are configured to jointly provide computing services. The electronic auction server may further be configured to receive and send data to and from user devices, computer devices associated with traders and other computers over the Internet, over a Wi-Fi connection, over a cellular network or via any other wired or wireless connection or network

In operation, electronic auction server may be configured to receive financial position data for at least one type of a financial asset traded on an electronic exchange. The financial position data may define a plurality of long and short positions held by a plurality of traders and associated with a first financial asset. This first financial asset may comprise, for example, a derivative instrument having an underlying financial asset.

The electronic auction server may further be configured to generate an invitation, transmit the invitation to trader devices and receive financial position data in response to the invitation via any kind of network known in the art. In one embodiment, the electronic auction server may be configured to receive financial position data during a predetermined time window.

The electronic auction server may also be configured to receive proposed mid-price data for the first financial asset and a second financial asset and to calculate a trade mid-point price for the first and second financial assets to be used in the exchange auction. The electronic auction server may use any of the algorithms known in the art for this calculation, as well as any proprietary algorithms.

In addition, the electronic auction server may further be configured to match at least one long position defined by the financial position data and an at least one short position defined by the financial position data. For example, the electronic auction server may be configured to match an MR CDS obligation held by a first trader with an MR CDS protection held by a second trader. The electronic auction server may also be configured to generate a plurality of matches via the matching process described above. This matching process may generate a plurality of bi-lateral matches between short and long positions. The electronic auction server may also be configured to match a single position with a plurality of other positions in a bi-lateral fashion. Thus, the electronic auction server may be configured to generate a collection of matched pairs, each pair comprising a matched short and a matched long position that may be used to form bilateral trades, as further discussed below.

The electronic auction server may further be configured to generate a first proposed trade including matched positions. In one embodiment, the matched long position may be associated with a first trader and the matched short position may be associated with a second trader. The first proposed trade may be a trade between the first trader and the second trader that results in a flattening of the long and short positions. In another embodiment, where the notional of the matched long position and the matched short positions are not the same, only one of the positions may be completely offset by the first proposed trade. The other position may only be partially offset by the first proposed trade.

The electronic auction server may also be configured to generate a second proposed trade associated with a second financial asset. The second financial asset may be associated with the same underlying financial asset as the first financial asset. For example, if the first financial asset is an MR CDS contract associated with a specific bond, the second financial asset may be an NR CDS contract associated with the same specific bond. The net notional of the second proposed trade may be equal to the net notional of the first proposed trade. In one embodiment, the second proposed trade may be designed to create replacement positions for the matched long and short positions that are being offset or flattened by the first proposed trade. The execution of the first and second proposed trades may result in an offsetting of the matched positions associated with a first financial asset and a creation of new replacement positions associated with a second financial asset, such that the notional of the replacement positions is equal to and offsets the notional of the matched positions associated with the first financial asset.

Optionally, the matched long position may belong to a first trader, and the matched short position may belong to a second trader. In such a scenario, the electronic auction server may be configured to generate the first proposed trade and the second proposed trade to be between the first and the second traders. For example, the first proposed trade between the first and the second traders may serve to offset the matched long and short positions, while the second proposed trade may serve to create replacement positions for the offset portions. Once the trades are generated, the electronic auction server may be configured to present the generated trades to the first and second traders for approval. Information relating to the proposed trades may be transmitted to traders' user devices and displayed on a user interface of each such user device. Subsequently, each of the traders may send an opt-out or opt-in indication to the electronic auction server for processing. In one embodiment, if the electronic auction server receives no indication within a predetermined period of time, it may be deemed as an acceptance or rejection of the proposed trades. If the opt-out indication is received from either of the traders or an opt-in indication is received from both traders, the electronic auction server may be configured to prevent execution of the first and the second proposed trades. If no opt-out indication is received, the electronic auction server may be configured to execute the first and the second proposed trades either simultaneously or consecutively.

In one embodiment, the electronic auction server may be configured to repeat the steps of matching positions and generating proposed trades for certain positions that were not offset during an auction. For example, it is possible that one trader has sent an opt-out indication while the trader's counterparty did not opt-out. In this scenario, the position of the counterparty who did not opt-out may be eligible for a re-match auction. The electronic auction server may be configured to include other positions in the re-match auction. The steps performed by the electronic auction server during the re-match auction may be similar to those performed in the auction described above.

### Exemplary Exchange Auction System

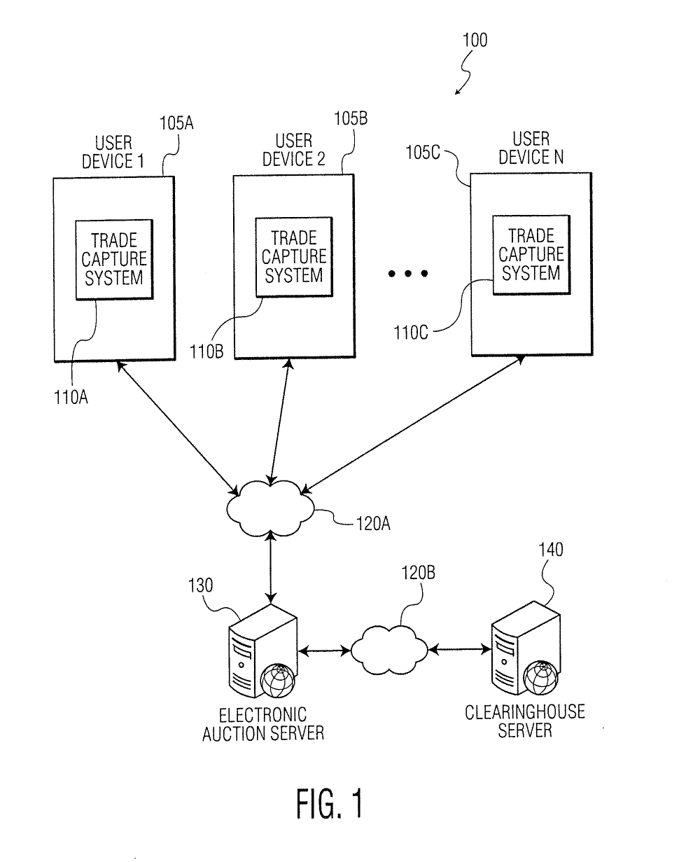

Turning now to FIG. 1, an exemplary system 100 configured for conducting an exchange auction according to this disclosure is shown. The system 100 comprises an electronic auction server 130, a clearinghouse server 140, and user devices 205A-205C. The exemplary system 100 may comprise an arbitrary amount of user devices. Each of the electronic auction server 130 and the clearinghouse server 140, may comprise one or more computing devices that include non-transitory memory for storing instructions and a processor for executing the instructions.

The electronic auction server 130, clearinghouse 140, and user devices 205A-205C may communicate with each other over one or more networks 120A, 120B. The networks 120A, 120B may comprise the Internet, Wi-Fi connections, cellular networks or any other wired or wireless connection or network known in the art. The user devices 105A-105C may comprise a desktop computer, a laptop, a smartphone or any other user device known in the art. Each of the user devices 105A-105C may comprise a trade capture system 110A-110C.

The electronic auction server 130 may be configured to receive financial position data from each of the user devices 105A-105C. The financial position data may be sent directly via user interface screen of each of the user device 105A-105C, via an upload process of XLS/CSV documents, via a web service provided by the electronic exchange server 130 or via any other means. The financial position data may define a plurality of long and short positions associated with a first financial instrument.

The electronic auction server 130 may further be configured to match at least one long and at least one short position using the techniques describe above. The electronic auction server 130 may also be configured to generate a first proposed trade involving the matched positions between the holders of the matched positions. In one embodiment, the first proposed trade may be designed to offset at least one of the matched positions. The electronic auction server 130 may also be configured to generate a second proposed trade associated with a second financial instrument. The second proposed trade may be designed to generate a replacement short position and a replacement long position for the offset matched positions. In one embodiment, the net notional of the second proposed trade may be equal to the net notional of the first proposed trade.

The electronic auction server 130 may send both the first and the second proposed trades to the user devices 105A-C of the traders associated with proposed trade (for example, to user device 1 105A and user device 2 105B). The electronic auction server 130 may then receive opt-in or opt-out messages from the user devices 105A, 105B. Consequently, the electronic auction server 130 may execute both the first and second proposed trades if no opt-out indication (or two opt-in indications) was received. In one example, the electronic auction server 130 may straight-through process the proposed trades via the trade capture systems 110A, 110B of the user devices 105A, 105B. In another embodiment, the electronic auction server 130 may submit the trades to the clearinghouse server 140 for processing.

A electronic auction server 130 may also be configured to execute the matching and trade generations steps for other long and short positrons defined by the financial positions data. The electronic auction server 130 may be configured to generate a plurality of bi-lateral matches between the traders associated with user devices 105A-105C. In addition, the electronic auction server 130 may further be configured to generate and execute trades pertaining to those matches in a manner similar to the processes described above.

### Exemplary Method for Processing Trade Orders

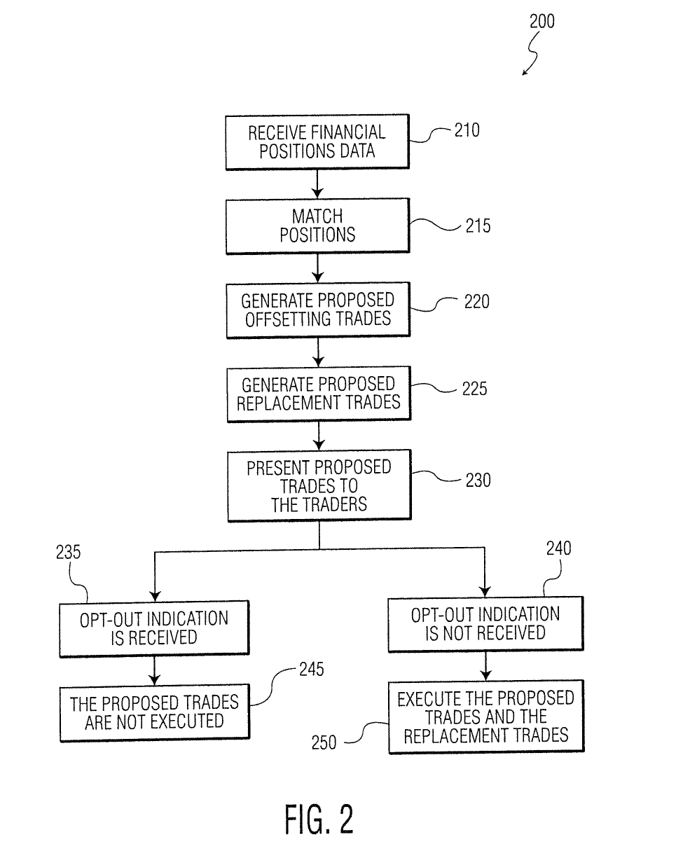

Turning now to FIG. 2, an exemplary method 200 for conducting an exchange auction is shown. The method 200 of FIG. 2 demonstrates an exemplary sequence of steps performed by an electronic auction server and/or any other properly configured computing device(s). The electronic auction server may comprise one or more computing devices that include non-transitory memory for storing instructions and a processor for executing the instructions to perform the steps of the illustrated method 200.

At 210, the electronic auction server may receive financial position data defining a plurality of long and short portions relating to a first financial asset. In one embodiment, the financial position data may be received from a plurality of user devices associated with traders holding the long and short positions.

At 215, the electronic auction server may execute a matching algorithm to match at least one of the long and at least one of the short portions. In another embodiment, the electronic auction server may create a plurality of bi-lateral matches between the long and short positions defined by the financial position data.

At 220, the electronic auction server may generate a first proposed trade including the matched short position and the matched long position for each bi-lateral match. At 225, the electronic auction server may further generate a second proposed trade that includes a new short and a new long position associated with a second financial asset. The proposed trade generated at step 225 may have the same net notional as the proposed trade generated at step 220. In one embodiment, the proposed trade generated at 220 may result in an offsetting of the matched short and long positions, while the proposed trade generated at 225 may result in creation of replacement positions for the offset positions.

At 230, the electronic auction server may present the proposed trades generated at 220 and 225 to the traders for review. For example, the propose trades may be transmitted to user devices associated with the traders. In one embodiment, at 235, the electronic auction server may receive an opt-out signal from at least on trader. In this embodiment, the electronic auction server may prevent the execution of the proposed trades at step 245. In another embodiment, at 240, the electronic auction server may not receive receive any opt-out signals (or receive opt-in signals). In this embodiment, the electronic auction server may, at step 250, execute both the trade generated at step 220 and the trade generated at step 225.

### Exemplary Proposed Trades Generated During an Exchange Auction

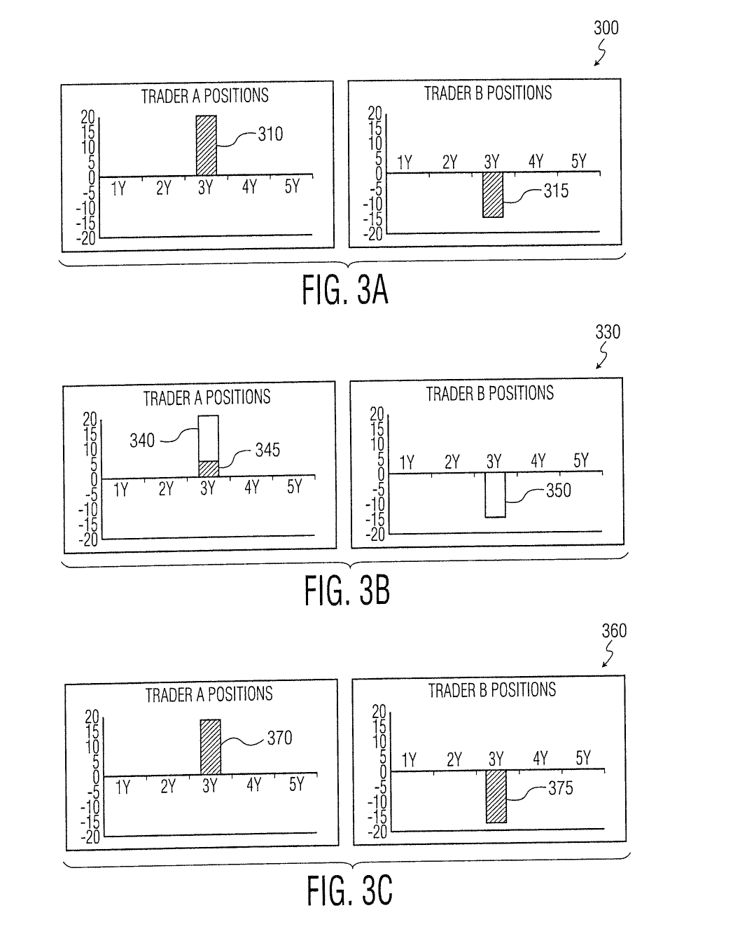

Turning now to FIGS. 3A-3C, exemplary financial asset positions that may be generated during an exemplary exchange auction described above are shown. The exemplary positions shown by FIGS. 3A-3C are presented as an example only, while it is understood that the method and system presented by this disclosure may be practice for a wide variety of other positions.

FIG. 3A shows initial matched positions 300 of Trader A and Trader B. These positions 300 include a matched long position 310 and a matched short position 315. These positions 310 and 315 are defined by financial position data received by an electronic exchange server. The matched short position 310 may be held by a first trader (Trader A). In the shown exemplary embodiment, the matched long position 310 is a net long $20 million 3 year MR CDS position. The matched long position 315 may be held by a second trader (Trader B). In the shown exemplary embodiment, the matched short position 310 is a net short $15 million 3 year MR CDS position.

FIG. 3B shows the positions 330 of Trader A and Trader B after the execution of a first proposed trade. This first proposed trade may have been generated by the exemplary exchange auction server and may include the matched short and the matched long positions of FIG. 3A. In the shown embodiment, the first proposed trade resulted in completely offsetting the matched short position 315 and offsetting (or flattening) a portion 340 of the matched long trade 310. In this exemplary embodiment, the execution of the first proposed trade resulted in Trader B holding a zero risk position 350 with respect to 3 year MR CDS contracts, and Trader A holding a flattened position 345 with respect to 3 year MR CDS contracts. In this example, the flattened position 345 is a long $5 million 3 year MR CDS position. In this exemplary embodiment, the net notional of the first proposed trade is $15 million. Subsequently, the first proposed trade resulted in flattening the exposure to 3 year MR CDS securities for both Trader A and Trader B.

FIG. 3C shows the positions 360 of Trader A and Trader B after the execution of a second proposed trade. This second proposed trade may have been generated by the exemplary exchange auction and may include a new short position and a new long position associated with a second financial asset. In this example, the second financial asset is a 3 year NR CDS contract. The second proposed trade may be designed to generate replacement positions for the matched positions 310, 315 that were offset by the first proposed trade. In this example, the execution of the second proposed trade generated a replacement long position 370 and a replacement short position 375. The replacement long position 370 may be a long $15 million 3 year NR CDS position held by Trader A and the replacement short position 375 may be a short $15 million 3 year NR CDS position held by Trader B. The notional of the second proposed trade may be equal to the notional of the first proposed trade. In this exemplary embodiment, the net notional of the second proposed trade is $15 million. The second proposed trade may be designed to generate replacement positions for the positions offset or flattened by the first proposed trade. The end result of executing both the first and second proposed trades may be replacement of a portion of an MR CDS position with an NR CDS position that has the same notional.

### Exemplary User Interface for Participating in the Exchange Auction

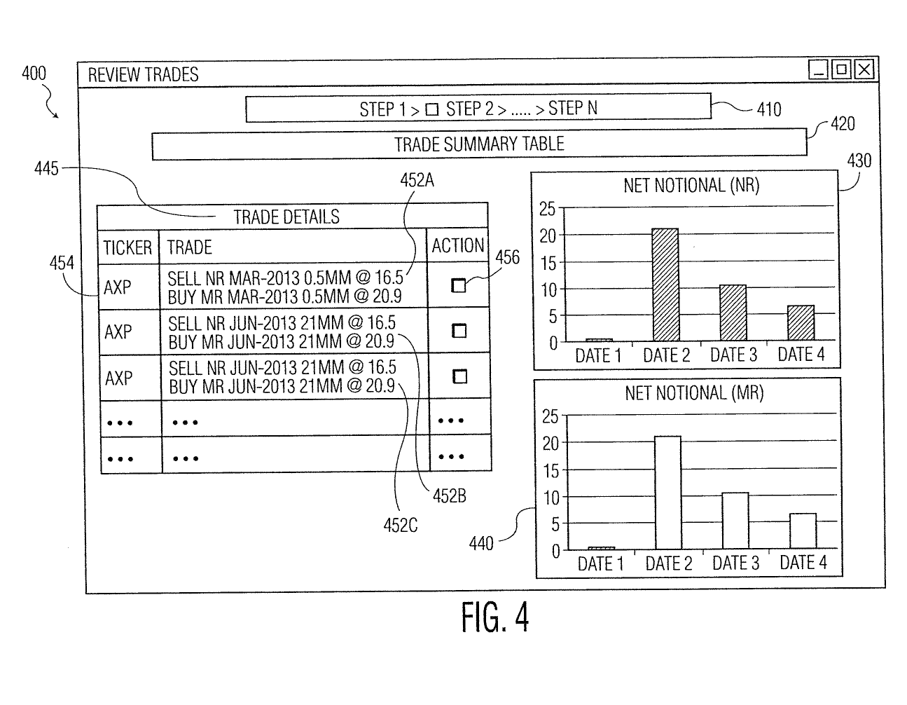

Turning now to FIG. 4, an exemplary graphical user interface 400 of a trader user device for participating in the exchange auction conducted by an electronic exchange server is shown. The trader user device may be in communication with the electronic exchange server. The graphical user interface 400 may be displayed on any type of display device including (without limitation) a computer monitor, a smart-phone screen, a laptop screen or any other type of device capable of displaying images. The exemplary graphical user interface 400 comprises the auction steps indicator 410, the trade summary table 420, the trade details table 445 and trade summary graphs 430, 440.

The auction steps indicator 410 may display the current step of the auction to a user. For example, the auction steps indicator 410 may indicate that the exchange auction is currently in data-submission stage, mid-review stage, trade review stage, or trade execution stage. The exemplary graphical user interface 400 shown in FIG. 4 demonstrates a trade review stage, however the graphical user interface 400 may also be configured to show graphical user interface elements relevant to other stages of the exchange auction. For example, during ae data-submission stage, the graphical user interface 400 may display graphical user interface elements that may be used by a trader to submit financial positions data to the electronic exchange server. During a mid-review stage, the graphical user interface 400 may display graphical user interface elements that may be used by the trader to reject or accept mid-prices determined by the electronic exchange server. During a trade execution stage, the graphical user interface 400 may display which trades were executed.

During a trade review stage the graphical user interface 400 may display graphical user interface elements that allow the trader to review proposed trades generated by the electronic exchange server. For example, the proposed trades may have been generated by the electronic exchange server according to the methods described above. During the trade review stage, the graphical user interface 400 may generate and display a trade summary table 420. The trade summary table 420 may provide an overview of all proposed trades generated by the electronic exchange server that concern the trader using the graphical user interface 400. In one embodiment, the trade summary table 420 may comprise information about the number of proposed trades for a plurality of financial instruments, each associated with a ticker 454. The trade summary table 420 may also comprise information about the percentage of propose trades that are accepted or canceled. The trade summary table 420 may also comprise information concerning profit and loss (P&L), net notional change and net delta change with regard to each financial instrument. In one embodiment, the trade summary table 420 may separately disclose statistical data relating to proposed trades involving MR CDS positions and NR CDS positions.

During the trade review stage the graphical user interface 400 may comprise a trade detail table 445. The trade detail table 445 may comprise information regarding each proposed trade generated by the electronic exchange server. The trade detail table 445 may show a ticker 454 of a financial asset associated with each trade. For example, the ticker 454 may be labeled “AXP.” The trade detail table 445 may further show detailed trade information 452A-C associated with financial instruments associated with the ticker 454. In the shown embodiment, the detailed trade information 452A may show trade details for an offsetting proposed trade and a replacement proposed trade generated by the exchange server using the method disclosed above. The detailed trade information 452A-C may comprise (without limit) the expiration data, trade disposition data, CDS type data, notional data and price data. For example, detailed trade information 452A shows detailed information about an offsetting trade and a replacement trade. The offsetting trade shown by the detailed trade information 452A is a purchase of $0.5 million position of MR CDS securities expiring in March, 2013 at a price of $20.9. The replacement trade shown by the detailed trade information 452A is a sale of $0.5 million position of NR CDS securities expiring in March, 2013 at a price of $16.5. Detailed trade information 452B similarly details an offsetting trade and the replacement trade for CDS securities expiring in June, 2013. Detailed trade information 452C similarly details an offsetting trade and the replacement trade for CDS securities expiring in September, 2013. In another embodiment, the trade detail table 445 may show detailed trade information for a plurality of other trades.

The trade detail table 445 may comprise an action button 456 associated with each detailed trade information 452A-C. Other buttons may also be associated with other detailed trade information table entries. The action button 456 may allow the trader to cancel the trades defined by the associated detailed trade information 452A. In particular, the action button 456 may allow the trader to cancel both the offsetting and the replacement trades defined by the detailed trade information 452A. In other embodiments, the action button 456 mays also allow the trader to perform other actions regarding the trades defined by the detailed trade information 452A. Other buttons may similarly allow the trader to take actions regarding proposed trades associated with detailed trade information 452B-C.

In another embodiment, the trade detail table 445 may comprise other information regarding proposed trades. For example, the trade detail table 445 may show one or more of the leg delta, leg P&L, trade ID and counterparty information associated with each proposed trade 452A-C. Other types of information may also be shown the trade detail table 445.

During a trade review stage, the graphical user interface 400 may comprise trade summary graphs 430, 440. The trade summary graphs 430, 440 may visually show the net notional of all proposed offsetting and replacement trades defined by detailed trade information 452A-C. For example, the trade summary graph 440 may visually demonstrate net notional amounts associated with all proposed MR CDS offsetting trades. For example, the trade summary graph 440 may show a bar corresponding to a plurality of MR CDS positions defined by the detailed trade information 452A-C, where each bar is associated with expiration date defined by one of the detailed trade information indicators 452A-C (e.g., Date 1, Date 2, Date 3, etc.) If the detailed trade information 452A-C defines trades associated with MR CDS securities with expiration dates in March 2013, June 2013 and September 2013, the trade summary graphs 440 may show a bar for each of those expiration dates. The length of each bar may be related to the notional of the MR CDS with the matching expiration date. For example, “Date 1” of the summary graph 440 may correspond to March, 2013, and the length of the bar above “Date 1” may be defined by the net national of the proposed trade involving MR CDS position expiring in March, 2013.

The trade summary graph 430 may show a bar corresponding to a plurality of NR CDS positions defined by the detailed trade information 452A-C, where each bar is associated with expiration date defined by the detailed trade information 452A-C (e.g. Date 1, Date 2, Date 3, etc.) For example, if the detailed trade information 452A-C defines trades associated with NR CDS securities with expiration dates in March 2013, June 2013 and September 2013, the trade summary graphs 430 may show a bar for each of those expiration dates. The length of each bar may be related to the notional of the NR CDS with the matching expiration date. For example, “Date 1” of the summary graph 430 may correspond to March, 2013, and the length of the bar above “Date 1” may be defined by the net national of the proposed trade involving NR CDS position expiring in March, 2013. However, the trade summary graphs 430, 440 may display graphical information about the proposed trades in other ways known in the art.

The foregoing embodiments and examples are provided merely for the purpose of explanation and are in no way to be construed as limiting. While reference to various embodiments is shown, the words used herein are words of description and illustration, rather than words of limitation. Further, although reference to particular means, materials, and embodiments are shown, there is no limitation to the particulars disclosed herein. Rather, the embodiments extend to all functionally equivalent structures, methods, and uses, such as those that are within the scope of the appended claims.

1. A method of conducting an exchange auction, the method comprising:
receiving, by at least one computer, financial position data defining one or more long positions and one or more short positions associated with a first financial asset;
matching, by the at least one computer, at least one of the one or more long positions with at least one of the one or more short positions associated with said first financial asset;
generating, by the at least one computer, a first proposed trade that includes the matched positions;
generating, by the at least one computer, a second proposed trade that includes one or more long positions and one or more short positions associated with a second financial asset, wherein a net notional associated with the first proposed trade is equal to a net notional associated with the second proposed trade; and
executing the first proposed trade and the second proposed trade.

2. The method of claim 1, wherein the first proposed trade is simultaneously executed with the second trade.

3. The method of claim 1, wherein each of the first financial asset and the second financial asset is a type of a derivative associated with a same underlying financial asset.

4. The method of claim 3, wherein the first financial asset is a modified restructuring (MR) credit default swap (CDS) contract and the second financial asset is a no restructuring (NR) CDS contract.

5. The method of claim 1, wherein executing the first proposed trade results in offsetting at least a portion of at least one of the matched positions.

6. The method of claim 5, wherein the long and short positions included in the second proposed trade correspond to offset portions of the matched positions that would result from executing the first proposed trade.

7. The method of claim 1, wherein the financial position data is received in response to an invitation, generated by the at least one computer, inviting one or more traders to participate in an exchange auction, said financial position data being received from one or more traders' computing devices in communication with the at least one computer.

8. The method of claim 1, further comprising:
receiving proposed mid-price data associated with the first financial asset;
calculating a trade price for the first proposed trade based on the proposed mid-price data associated with said first financial asset;
receiving proposed mid-price data associated with the second financial asset; and
calculating a trade price for the second proposed trade based on the proposed mid-price data associated with the second financial asset.

9. The method of claim 1, further comprising:
receiving proposed mid-price data associated with at least one of the first financial asset and the second financial asset;
receiving a proposed spread between the first financial asset and the second financial asset; and
calculating a trade price for the first proposed trade and a trade price for the second proposed trade based on the proposed mid-price data and the proposed spread.

10. The method of claim 1, wherein at least one of the matched long positions is held by a first trader and at least one of the matched short positions is held by a second trader, and wherein the first trader and the second trader are counterparties to each of the first proposed trade and the second proposed trade.

11. The method of claim 1, further comprising:
presenting the first proposed trade and the second proposed trade to a first trader and a second trader via one or more trader computing devices for approval; and
receiving an opt-out indication from at least one of the first trader and the second trader via the one or more trader computing devices, wherein receipt of said opt-out indication prevents execution of both the first proposed trade and the second trade,
wherein if the opt-out indication is received from only one of the first and second traders, repeating the matching and generating steps for at least one of the matched positions belonging to the trader from which the opt-out indication was not received.

12. The method of claim 1, wherein at least one of the long positions and short positions associated with the second financial asset is a replacement position for at least one of the matched positions associated with the first financial asset, and wherein at least one of the long positions and short positions has a notional that is equal to a notional of at least one of the matched positions.

13. The method of claim 1, wherein the financial position data is received during a predetermined time window.

14. The method of claim 1, wherein the financial position data includes position tenor data that indicates a tenor of between zero and ten years, in quarterly increments, for the long and short positions defined by said financial position data.

15. The method of claim 1, wherein the matching step comprises multi-laterally matching three or more positions associated with the first financial asset such that at least one long position is matched with two or more short positions or at least one short position is matched with two or more long positions, wherein generating the first proposed trade comprises generating a first collection of proposed bilateral trades involving the multi-laterally matched positions, and wherein generating the second proposed trade includes generating a second collection of bilateral trades involving long and short positions associated with the second financial asset.

16. A system for conducting an exchange auction, the system comprising:
an electronic auction server comprising at least on processor and at least one non-transitory computer-readable storage medium having computer-readable program code portions stored therein, wherein the computer-readable program code portions, when executed, cause the electronic auction server to:
receive financial position data defining one or more long positions and one or more short positions associated with a first financial asset;
match at least one of the one or more long positions with at least one of the one or more short positions associated with said first financial asset;
generate a first proposed trade that includes the matched positions;
generate a second proposed trade that includes one or more long positions and one or more short positions associated with a second financial asset, wherein a net notional associated with the first proposed trade is equal to a net notional associated with the second proposed trade; and
execute the first proposed trade and the second proposed trade.

17. The system of claim 16, wherein the computer-readable program code portions further cause the electronic exchange server to execute the first proposed trade simultaneously with the second trade.

18. The system of claim 16, wherein each of the first financial asset and the second financial asset is a type of a derivative associated with a same underlying financial asset.

19. The system of claim 18, wherein the first financial asset is a modified restructuring (MR) credit default swap (CDS) contract and the second financial asset is a no restructuring (NR) CDS contract.

20. The system of claim 16, wherein executing the first proposed trade results in offsetting at least a portion of at least one of the matched positions.

21. The system of claim 20, wherein the long and short positions included in the second proposed trade correspond to offset portions of the matched positions that would result from executing the first proposed trade.

22. The system of claim 16, wherein the computer-readable program code portions further cause the electronic exchange server to receive the financial position data in response to an invitation, generated by the electronic exchange server, inviting one or more traders to participate in an exchange auction, said financial position data being received from one or more traders' computing devices in communication with the electronic exchange server.

23. The system of claim 16, wherein the computer-readable program code portions further cause the electronic exchange server to:
receive proposed mid-price data associated with the first financial asset;
calculate a trade price for the first proposed trade based on the proposed mid-price data associated with said first financial asset;
receive proposed mid-price data associated with the second financial asset; and
calculate a trade price for the second proposed trade based on the proposed mid-price data associated with the second financial asset.

24. The system of claim 16, wherein the computer-readable program code portions further cause the electronic exchange server to:
receive proposed mid-price data associated with at least one of the first financial asset and the second financial asset;
receive a proposed spread between the first financial asset and the second financial asset; and
calculate a trade price for the first proposed trade and a trade price for the second proposed trade based on the proposed mid-price data and the proposed spread.

25. The system of claim 16, wherein at least one of the matched long positions is held by a first trader and at least one of the matched short positions is held by a second trader, and wherein the first trader and the second trader are counterparties to each of the first proposed trade and the second proposed trade.

26. The system of claim 16, wherein the computer-readable program code portions further cause the electronic exchange server to:
present the first proposed trade and the second proposed trade to a first trader and a second trader via one or more trader computing devices for approval; and
receive an opt-out indication from at least one of the first trader and the second trader via the one or more trader computing devices, wherein receipt of said opt-out indication prevents execution of both the first proposed trade and the second trade,
wherein if the opt-out indication is received from only one of the first and second traders, the computer-readable program code portions further causing the electronic exchange server to repeat the matching and generating steps for at least one of the matched positions belonging to the trader from which the opt-out indication was not received.

27. The system of claim 16, wherein at least one of the long positions and short positions associated with the second financial asset is a replacement position for at least one of the matched positions associated with the first financial asset, and wherein at least one of the long positions and short positions has a notional that is equal to a notional of at least one of the matched positions.

28. The system of claim 16, wherein the financial position data is received by the electronic exchange server during a predetermined time window.

29. The system of claim 16, wherein the financial position data includes position tenor data that indicates a tenor of between zero and ten years, in quarterly increments, for the long and short positions defined by said financial position data.

30. The system of claim 16, wherein the computer-readable program code portions further cause the electronic exchange server to multi-laterally match three or more financial positions associated with the first financial asset such that at least one long position is matched with two or more short positions or at least one short position is matched with two or more long positions, wherein generating the first proposed trade comprises generating a first collection of proposed bilateral trades involving the multi-laterally matched positions, and wherein generating the second proposed trade includes generating a second collection of bilateral trades involving long and short positions associated with the second financial asset.
